(19) United States
(12) Patent Application Publication
(10) Pub. No.: US 2026/0146154 A1
(43) Pub. Date: May 28, 2026

(54) HYDROSTABLE THERMOPLASTIC COMPOSITION

(71) Applicant: SABIC GLOBAL TECHNOLOGIES B.V., Bergen op Zoom (NL)

(72) Inventors: Roshan Kumar JHA, Bangalore (IN); Rukmini KHATOKAR, Bangalore (IN); Anirban GANGULY, Bangalore (IN); Kavya AT, Bengaluru (IN)

(21) Appl. No.: 19/121,200

(22) PCT Filed: Oct. 2, 2023
(86) PCT No.: PCT/EP2023/077202

§ 371 Date: Apr. 15, 2025

(30) Foreign Application Priority Data
Oct. 18, 2022 (EP) 22202258.4
Oct. 18, 2022 (EP) 22202260.0
Oct. 18, 2022 (EP) 22202265.9

(51) Int. Cl. C08L 69/00; C08K 3/32

(52) U.S. Cl. CPC C08L 69/00; C08K 3/32; C08K 2003/328; C08L 2203/20; C08L 2203/30; C08L 2205/035

(57) ABSTRACT

A thermoplastic composition including, based on the weight of the composition
(A) from 40 to 70 wt. % of aromatic polycarbonate
(B) from 20 to 40 wt. % of polyester
(C) from 1 to 15 wt. % of impact modifier
(D) from 0.1 to 10 wt. % of a hydrolytic stabilizer composition including at least one compound containing diimide functional groups
(E) from 0 to 5 wt. % of other components
   wherein the composition is selected to have, in combination,
an initial notched Izod impact determined in accordance with ISO 180-1A at a temperature of 23° C. of at least 50 kJ/m²,
a notched Izod impact retention of at least 70% determined in accordance with the method set out in the description,
a heat distortion temperature, determined in accordance with ISO 75A flatwise at a load of 1.8 MPa, of at least 90° C.

### CROSS REFERENCE TO RELATED APPLICATIONS

This application is a National Stage application of PCT/EP2023/077202, filed Oct. 2, 2023, which claims the benefit of European Application No. 22202258.4, filed Oct. 18, 2022, European Application No. 22202260.0, filed Oct. 18, 2022, and European Application No. 22202265.9, filed Oct. 18, 2022, all of which are incorporated by reference in their entirety herein.

### BACKGROUND

The present invention relates to a hydrostable thermoplastic composition comprising polycarbonate and polyester. The present invention further relates to an article comprising or consisting of such a composition.

Compositions comprising polycarbonate and polyester have excellent appearance, mechanical properties, dimensional stability, and chemical resistance, and are widely used in various fields. Particularly, a composition composed of polycarbonate and poly(butylene terephthalate), PBT, imparts excellent mechanical properties (such as impact, ductility and dimensional stability) and chemical resistance to the polycarbonate. These compositions are useful in fields such as interior and exterior parts in automobiles specifically.

However, polyesters like PBT having a relatively high amount of —COOH end groups may affect the stability of the polycarbonate in polyester-polycarbonate blends. It is believed that the —COOH end groups of the polyester may cause the polycarbonate to lose molecular weight, resulting in a change of properties of the same. This effect may be enhanced by the presence of catalysts or catalyst residues that may be applied during the manufacture of the polycarbonate.

U.S. Pat. No. 9,920,198 discloses a blend of polycarbonate (PC) and poly(lactic acid) (PLA) comprising (a) branched bisphenol APC, (b) PLA, (c) a chain extender, and (d) a glycidyl methacrylate (GMA) functionalized polyolefin copolymer/terpolymer.

U.S. Pat. No. 7,923,506 discloses a molding composition comprising: (a) from 20 to 49.9 wt % of a first polyester component having an intrinsic viscosity ranging from 0.5 to 1.0 and comprising: a first polybutylene terephthalate random copolymer that (1) is derived from polyethylene terephthalate copolymers and (2) has at least one residue derived from the polyethylene terephthalate component, and (b) from 20 to 49.9 wt % of a second polyester component having an intrinsic viscosity ranging from 1.1 to 1.4 and comprising: a second polybutylene terephthalate random copolymer that (1) is derived from polyethylene terephthalate component selected from the group consisting of polyethylene terephthalate and polyethylene terephthalate copolymers and (2) has at least one residue derived from the polyethylene terephthalate component, and (c) from 0.01 to 20 wt. % of a carboxy reactive component; wherein the first polyester component, the second polyester component, and optionally at least one additive, are present in a total amount of 100 wt %.

The impact properties of compositions comprising polycarbonate and polyester may be enhanced by addition of suitable impact modifiers. Such impact modifiers may be prepared by means of an emulsion polymerization process involving the use of process aids such as emulsifiers and coagulation agents. Such process aids, to the extent these would be part of the impact modifier, may also cause decomposition of the polycarbonate, i.e. promote hydrolysis.

Further to the foregoing, it is common to add quenchers to compositions comprising polycarbonate and polyester in order to prevent transesterification of the polyester and the polycarbonate. Such quenchers are typically mildly acidic. In order to maintain a certain level of hydrolytic stability of the composition this quencher needs to be selected such that it is acidic enough to quench residual catalyst in the polyester, but at the same time it does not significantly result in hydrolysis of the polycarbonate.

Therefore, in demanding applications, whereby in particular the compositions may be exposed to humidity at high temperature, it is desired to provide compositions comprising polycarbonate and polyester having an improved hydrolytic stability.

### SUMMARY

It is an object of the present invention to provide a thermoplastic composition having good initial mechanical properties and being suitable for use in applications wherein the composition may be exposed to humidity at high temperatures.

It is a further object of the invention to provide for a thermoplastic composition comprising polycarbonate and polyester, wherein the composition has, in combination, good hydrostability, impact properties and heat stability

These objects are met, at least in part, in accordance with the present invention, which is directed at a thermoplastic composition comprising, based on the weight of the composition
(A) from 40 to 70 wt. % of aromatic polycarbonate
(B) from 20 to 40 wt. % of polyester
(C) from 1 to 15 wt. % of impact modifier
(D) from 0.1 to 10 wt. % of a hydrolytic stabilizer composition comprising at least one compound containing diimide functional groups
(E) from 0 to 5 wt. % of other components
   wherein, the combined amounts of (A) to (E) is 100 wt. %, and wherein the composition has, or is selected to have, in combination,
an initial notched Izod impact determined in accordance with ISO 180-1A at a temperature of 23° C. of at least 50 kJ/m²,
a notched Izod impact retention of at least 70% determined in accordance with the method set out in the description,
a heat distortion temperature, determined in accordance with ISO 75A flatwise at a load of 1.8 MPa, of at least 90° C.

### DETAILED DESCRIPTION

The invention will now be described in more detail.

### Aromatic Polycarbonate

In the context of the present invention the term polycarbonate is to be understood as meaning an aromatic polycarbonate. Both of the terms “polycarbonate” and “aromatic polycarbonate” accordingly shall have the same meaning and may be used interchangeably. An aromatic polycarbonate, as known to the skilled person, is a polycarbonate comprising aromatic groups.

Aromatic polycarbonates are generally manufactured using two different technologies. In a first technology, known as the interfacial technology or interfacial process, phosgene is reacted with a bisphenol, typically bisphenol A (BPA) in a liquid phase. Another well-known technology is the so-called melt technology, sometimes also referred to as melt transesterification or melt polycondensation technology. In the melt technology, or melt process, a bisphenol, typically BPA, is reacted with a carbonate, typically diphenyl carbonate (DPC), in the melt phase. Aromatic polycarbonate obtained by the melt transesterification process is known to be structurally different from aromatic polycarbonate obtained by the interfacial process. In that respect it is noted that in particular the so called “melt polycarbonate” typically has a minimum amount of Fries branching, which is generally absent in “interfacial polycarbonate”. Apart from that melt polycarbonate typically has a higher number of phenolic hydroxy end groups while polycarbonate obtained by the interfacial process is typically end-capped and has at most 150 ppm, preferably at most 50 ppm, more preferably at most 10 ppm of phenol hydroxyl end-groups. Typically, the amount of phenol hydroxyl end-groups is below the detection limit.

In accordance with the invention, it is preferred that the aromatic polycarbonate comprises or consists of bisphenol A polycarbonate or a mixture of bisphenol A polycarbonates, preferably wherein at least part of the bisphenol A polycarbonate is prepared by the melt transesterification of bisphenol A and diphenyl carbonate. Preferably, the aromatic polycarbonate of the invention disclosed herein comprises at least 75 wt. %, preferably at least 95 wt. % of bisphenol A polycarbonate based on the total amount of aromatic polycarbonate. More preferably, the aromatic polycarbonate in the composition essentially consists or consists of bisphenol A polycarbonate. It is preferred that the aromatic polycarbonate has a weight average molecular weight (Mw) of 15,000 to 60,000 g/mol determined using gel permeation chromatography with polystyrene standards. Preferably, the Mw of the aromatic polycarbonate is from 20,000 to 45,000 g/mol. If the polycarbonate is a mixture of two or more aromatic polycarbonates then the Mw is to be determined on the basis of the mixture wherein preferably each of the aromatic polycarbonates constituting the mixture has a Mw from 20,000 to 45,000 g/mol.

In an aspect, the aromatic polycarbonate is an interfacial polycarbonate.

In another aspect, the aromatic polycarbonate is a melt polycarbonate.

In yet another aspect the aromatic polycarbonate is a mixture of from 20-80 wt. % or 40-60 wt. % of interfacial polycarbonate and from 80-20 wt. % or 60-40 wt. % of melt polycarbonate, based on the weight of the aromatic polycarbonate.

The aromatic polycarbonate may have a melt volume rate (MVR), determined in accordance with ISO 1133 (300° C., 1.2 kg) of 1 to 50 cc/10 min, specifically 2 to 30 cc/10 min, such as 10-15 cc/10 min. The aromatic polycarbonate may comprise two or more aromatic polycarbonates differing in melt volume rate (i.e. in molecular weight). The aromatic polycarbonates of the mixture may both be a bisphenol A polycarbonate homopolymer. In another aspect the aromatic polycarbonate may comprise a polycarbonate copolymer comprising structural units of bisphenol A and structural units from another bisphenol.

### Polyester

The polyester of the composition disclosed herein comprises at least 80 wt. %, preferably at least 90 wt. % of poly(butylene terephthalate) (PBT), based on the weight of the polyester. More preferably the polyester of the composition disclosed herein essentially consists or consists of poly(butylene terephthalate). The PBT may be a mixture of two or more different poly(butylene terephthalate) s, for example a mixture of PBTs with mutually different intrinsic viscosities. The polyester may further comprise mechanically recycled PBT or PBT obtained from (chemically) recycled poly(ethylene terephthalate) (PET). Polyesters such as PBT and PET are well known to a skilled person per se.

The PBT may be a single polymer or may be a combination of two or more, preferably two PBT's having mutually different properties. For example, the PBT may comprise a first PBT and a second PBT each having a different intrinsic viscosity. The PBT in the composition of the invention may accordingly be a blend of such a first and second (or further) PBTs. In this aspect, the first PBT may have an intrinsic viscosity of from 1.1-1.4 dl/g and the second PBT may have an intrinsic viscosity of from 0.6-0.8 dl/g.

In accordance with the invention, the polyester may have an intrinsic viscosity of 0.4 to about 2.0 dl/g as measured in a 60:40 phenol/tetrachloroethane mixture at 23° C. In the aspect where the polyester is a mixture then this preferred feature applies to the said mixture.

It is preferred that the polyester comprises at least 50 wt. %, preferably at least 80 wt. %, more preferably at least 90 or 95 wt. % of PBT on the basis of the weight of the polyester. Preferably, the polyester consists of PBT. Preferably, PBT is the only polyester in the composition.

In an aspect, the polyester may further comprise another polyester, miscible with PBT. Such polyesters include poly(ethylene terephthalate), poly(ethylene naphthalate) (PEN), poly(butylene naphthalate) (PBN), poly(propylene terephthalate) (PPT), poly(cyclohexane dimethanol terephthalate) (PCT), poly(cyclohexane-1,4-dimethylene cyclohexane-1,4-dicarboxylate) also referred to as poly(1, 4-cyclohexane-dimethanol 1,4-dicarboxylate) (PCCD) and copolyesters, PCTG and PETG, preferably PET. In accordance with this aspect of the invention, the composition preferably comprises from 99 to 80 wt. % of PBT and from 1 to 20 wt. % of one or more of said further polyesters, based on the weight of the polyester. It is preferred that the further polyester is PET.

In an aspect, where the polyester comprises PBT, a mixture of PBTs and a polyester not being PBT then the intrinsic viscosity of the polyester is preferably from 0.6-1.4 dl/g. The PBT may have a carboxylic end group content of from 10-80 mmol/kg, preferably from 20-60 mmol/kg, more preferably 20-40 mmol/kg as determined in accordance with ASTM D7409-15.

In accordance with the invention the polyester preferably does not comprise or consist of poly(lactic acid) such as in particular the material identified as “PLA” in U.S. Pat. No. 9,920,198. In accordance with the invention the thermoplastic composition preferably does not comprise poly(lactic acid) such as in particular the material identified as “PLA” in U.S. Pat. No. 9,920,198.

### Impact Modifier

The thermoplastic composition of the invention comprises an impact modifier. Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers are also used.

The impact modifier comprises or consist of at least one of acrylonitrile-butadiene-styrene (ABS) polymer and/or methyl-methacrylate butadiene-styrene (MBS) polymer. The amount of impact modifier may be from 1-15 wt. % based on the weight of the composition. Preferably the impact modifier is comprised in the composition in an amount of from 2-12 wt. %, more preferably from 4-8 wt. %.

### Hydrolytic Stabilizer

In accordance with the invention, the thermoplastic composition with improved hydrolytic stability of the present invention comprises from 0.1 to 10 wt. %, preferably from 0.5 to 3 wt. % of a hydrolytic stabilizer composition comprising at least one compound containing diimide functional groups, based on the weight of the composition. It is preferred that the composition comprises at least 80 wt. %, preferably 90 wt. % to 100 wt. % of at least one compound containing diimide functional groups, based on the weight of the hydrolytic stabilizer composition.

In accordance with the invention, the hydrolytic stabilizer composition comprises at least one compound containing at least one diimide functional group. These compounds are known and available in commerce, e.g., Stabaxol P a product of Rhein Chemie Corporation and may be prepared by known methods (for instance European Patent No. 582983; Japanese Patent Publication No. 33279/1972; Journal of Organic Chemistry, 28, 2069-2075 91963); Chemical Review 1981, vol. 81, No. 4, 619-621; Journal of Applied Polymer Science, 1977, vol. 21, 1999-2008, all incorporated herein by reference).

In another aspect, the hydrolytic stabilizer composition further comprises at least one compound containing epoxy functional groups. It is preferred that the composition comprises at least 80 wt. %, preferably 90 wt. % to 100 wt. % of the combined amount of a compound, or compounds, containing epoxy functional groups and a compound, or compounds, containing diimide functional groups based on the weight of the hydrolytic stabilizer composition.

The said epoxy compound may have one or more epoxy functional groups. The term “polyfunctional epoxy compound” is defined to embrace a compound having at least two epoxy functional groups. A preferred difunctional epoxy compound is 3,4-epoxycyclohexyl-3,4-epoxycyclohexylcarboxylate, commercially available as ERL-4221 epoxy from Union Carbide. Examples of other preferred difunctional epoxy compounds are bis(3,4-epoxycyclohexylmethyl)adipate, vinylcyclohexene di-epoxide, bisphenol diglycidyl ethers, diglycidyl adducts of amides, diglycidyl adducts of carboxylic acids and the like.

Other hydrolytic stabilizers comprising epoxy functional groups may be an ethylene and/or a styrene copolymer, which include repeat units derived from ethylene, and an epoxy comonomer including, for example, glycidyl acrylate, glycidyl methacrylate, glycidyl butyl acrylate, glycidyl vinyl ether, or combinations of two or more thereof. Frequently used ethylene and/or styrene copolymers can further comprise repeat units derived from an ester of unsaturated carboxylic acid including (meth)acrylate or C₁ to C₈ alkyl(meth)acrylate, or combinations of two or more thereof. “(Meth)acrylate”, refers to acrylate, alkyl acrylate, methacrylate, or combinations of two or more thereof. Examples of alkyl acrylates include methyl acrylate, ethyl acrylate and butyl acrylate.

The ethylene and/or styrene copolymer can also comprise, consist essentially of, or consist of, repeat units derived from ethylene and/or styrene and an epoxy comonomer including, for example, a glycidyl ester of acrylic acid or methacrylic acid, glycidyl vinyl ether, or combinations thereof, and an additional comonomer such as carbon monoxide. Such epoxy compounds are commercially available or can be made by techniques well known to those skilled in the art.

### Other Components

The thermoplastic composition disclosed herein comprise from 0-5 wt. % of other components, preferably selected from the group consisting of reinforcing or non-reinforcing fillers, such as for example talc, calcium carbonate, glass flakes, glass fibers and the like, antifog agents, plasticizers, flow enhancing additives, lubricants, pigments, dyes, flame retardants, nucleating agents, thermal stabilizers, UV absorbers, UV stabilizers, dispersants, surfactants, antistatic agents, slip agents, or combinations of two or more thereof. Such further components are known to the skilled person per se.

It is preferred that the other components in accordance with the present invention comprises, based on the weight of the composition, from 0.01 to 1 wt. % of a compound selected from the group consisting of Group IB metal phosphate salts and Group IIB metal phosphate salts. Preferably, the compound is selected from the group consisting of Group IB and/or Group IIB metal acid phosphates, metal acid pyrophosphates, and metal polyphosphates, more preferably the catalyst quencher is a zinc phosphate salt. This compound is used as a quencher for catalyst or catalyst residues in the polyester.

It is preferred that the other components comprises, based on the weight of the composition, from 0.01 to 1 wt. %, preferably from 0.03 to 0.5 wt. %, of a compound containing at least one of alkali metal cations or alkaline earth metal cations and a halide anion, preferably selected from one or more of the group comprising of lithium fluoride, lithium iodide, potassium bromide, potassium iodide, sodium dihydrogen phosphate, sodium acetate, sodium benzoate, sodium caproate, sodium stearate, sodium ascorbate and magnesium caproate.

### Composition

The combination of specific types and amounts materials constituting the thermoplastic composition results in a property profile in terms of, in particular, hydrostability, mechanical and thermal properties. The examples and comparative examples disclosed herein provide the skilled person with materials that fall inside and outside the scope of the invention respectively, and thereby constitute a basis for the development of further embodiments according to the invention without undue burden.

In accordance with the invention the thermoplastic composition comprises, based on the weight of the composition,
(A) from 40 to 70 wt. % of aromatic polycarbonate
(B) from 20 to 40 wt. % of polyester
(C) from 1 to 15 wt. % of impact modifier
(D) from 0.1 to 10 wt. % of a hydrolytic stabilizer composition comprising at least one compound containing diimide functional groups
(E) from 0 to 5 wt. % of other components
wherein, the combined amounts of (A) to (E) is 100 wt. %.

The amount of component (A) may be from 50 to 70 wt. %.

The amount of component (B) may be from 25 to 35 wt. %.

The amount of component (C) may be from 2 to 12 wt. %.

The amount of component (D) may be from 0.5 to 3 wt. %.

The amount of component (E) may be from 0.01 to 3 wt. %.

Preferably, the component (B) comprises or consists of poly(butylene terephthalate).

Preferably, the component (D) comprises a hydrolytic stabilizer composition comprising at least one compound containing carbodiimide functional groups.

For the avoidance of doubt the skilled person will understand that the total weight of the composition will be 100 wt. % and that any combination of materials which would not form 100 wt. % in total is unrealistic and not according to the invention.

In accordance with the invention, the thermoplastic composition is selected to have in combination;
an initial notched Izod impact determined in accordance with ISO 180-1A at a temperature of 23° C. of at least 50 kJ/m²,
a notched Izod impact retention of at least 70% determined in accordance with the method set out in the description,
a heat distortion temperature, determined in accordance with ISO 75A flatwise at a load of 0.45 MPa, of at least 90° C., preferably 90° C. to 120° C.

In a preferred aspect, the thermoplastic composition exhibits a notched Izod impact retention of at least about 5%, preferably at least about 10%, more preferably at least about 20% higher than that of an identical composition, but not containing component (D).

Preferred ranges for the amount of the components and preferred ranges for the properties of the composition may be combined without limitation, provided of course that these fall within the scope of the invention as defined herein in its broadest form. That is to say, a preferred range for one or more of the amounts and/or types of the components constituting the thermoplastic composition may be combined with a preferred range for one or more of the properties of the thermoplastic composition and all such combinations are considered as disclosed herein.

The compositions can be manufactured by various methods known in the art. For example, polycarbonate, polyester, and other components are first blended, optionally with any additives, in a high-speed mixer or by hand mixing. The blend is then fed into the throat of a twin-screw extruder via a hopper.

Preferably, the thermoplastic composition is prepared by the method comprising the steps of:
a) combining polyester with the hydrolytic stabilizer composition and optionally the other components, in a first melt mixing device so as to form a stabilized polyester,
b) combining said stabilized polyester with polycarbonate and the impact modifier in a second melt mixing device.

The product from the second melt mixing device can be fed into the extruder. The extruder was set with barrel temperatures between 150° C. and 260° C. The extrudate can be immediately cooled in a water bath and pelletized. The pellets so prepared can be 0.6 cm long or less as desired. Such pellets can be used for subsequent molding, shaping, or forming.

Shaped, formed, or molded articles comprising the compositions are also provided. The compositions can be molded into articles by a variety of methods, such as injection molding, extrusion, and thermoforming. Some example of articles include automotive and vehicular body panels such as bumper covers and bumpers or a housing for electrical equipment.

Accordingly, the present invention relates to an article comprising or consisting of the thermoplastic composition or obtainable by the method disclosed herein, wherein preferably the article is an automotive interior article, or a housing for electrical equipment.

More in particular, the present invention relates to vehicular body parts or for housing of electrical equipment comprising or consisting the thermoplastic composition disclosed herein. Likewise, the present invention relates to a an article that comprises or constitutes any one or more selected from the group consisting of instrument panels, cup holders, glove boxes, dashboards, dashboard carriers, door claddings, door fixtures, armrests, pillar cladding, seat cladding, boot cladding and parts used in heating, ventilation and/or air conditioning instruments. Furthermore, the present invention relates to a vehicle or an electrical equipment comprising said vehicular body part or said housing. The present invention relates to the use of the thermoplastic composition, or obtainable by the method disclosed herein for the manufacture of an article of manufacture, preferably an automotive part, more preferably an interior automotive part.

The present invention will now be further elucidated based on the following non-limiting examples.

Test Methods

| | |
|---|---|
| Impact & | Notched Izod impact (NII) properties were determined in |
| Hydro-ageing | accordance with to ISO 180/1A on injection molded samples being |
| | 80 × 10 × 4 mm in size. |
| | The initial test was carried out at 23° C. The impact energy is |
| | expressed in kJ/m². The test result is the average of 5 specimens. |
| | This gives the initial notched Izod impact or NII @ RT. |
| | Hydro-ageing is done at 85° C. and 85% Relative Humidity for 168 |
| | hours and the NII properties (in kJ/m²) were measured post hydro- |
| | ageing according to ISO 180/1A after cooling the test samples to |
| | 23° C. The test result is the average of 5 specimens. This gives the |
| | final notched Izod impact or NII @ HA. |
| | The notched Izod impact retention (in %) upon hydro-ageing or NII |
| | Ret, is calculated as 100% × (NII@HA/NII@RT) |
| Intrinsic viscosity | The intrinsic viscosity of the polyesters was measured in a 3:2 |
| | weight to weight mixture of phenol:1,2-dichlorobenzene at 25° C.. |
| Heat distortion | The heat distortion temperature, HDT (in ° C.) was determined in |
| temperature | accordance with ISO 75A flatwise at a load of 1.8 MPa. |
| (HDT) | |
| Molecular weight | The molecular weight of the polycarbonate and poly(butylene |
| | terephthalate) was measured by GPC method with polystyrene |
| | standard in an Agilent 1260 Infinity (SYS-LC-1260) equipment with |
| | PLGel 5 μm Minimix C 250 × 4.6 mm column and Refractive Index |
| | detector. The sample is dissolved in dichloromethane and the same |
| | solvent is used as carrier. |
| Tensile modulus | Tensile modulus was determined in accordance with ISO 527 at a |
| | temperature of 23° C. measured on injection molded specimens |
| | having dimensions of 170 × 10.0 × 4.0 mm. |
| Tensile strength | Tensile strength was determined in accordance with ISO 527 at a |
| | temperature of 23° C. measured on injection molded specimens |
| | having dimensions of 170 × 10.0 × 4.0 mm |
| Elongation at | Tensile yield, or elongation at break, was determined in accordance |
| break (EB) | with ISO 527 at a temperature of 23° C. measured on injection |
| | molded specimens having dimensions of 170 × 10.0 × 4.0 mm |
| Melt volume rate | The melt volume rate was determined in accordance with ISO |
| (MVR) | 1133. For polycarbonate, measurements were carried out at a |
| | temperature of 300° C. and a load of 1.2 kg. For the compositions, |
| | measurements were carried out at a temperature of 250° C. and a |
| | load of 5.0 kg. |

### EXAMPLES

The samples were molded by injection molding on L&T ASWA 100T Injection molding machine at 260° C., keeping the mold temperature set at 100° C. for all compositions. The components of the compositions and their source are listed in Table 1.

TABLE 1
Components of the compositions and their source

| | |
|---|---|
| PC | Bisphenol A polycarbonate manufactured using an interfacial process, |
| | having a melt volume rate of 6 cc/10 min, available from SABIC (PC 105) |
| PBT | Polybutylene terephthalate having an intrinsic viscosity of 1.2 dl/g as |
| | measured in a 1:1 weight to weight mixture of phenol:1,1,2,2 - tetrachloro |
| | ethane at 25° C. available from Chang Chun Plastics, Taiwan |
| ABS | HRG181 High Rubber Graft ABS Impact modifier having a polybutadiene |
| | content of 55 wt. %, available from Kumho, Korea |
| MBS | Paraloid MBS EXL 2650J core shell impact modifier having a polybutadiene |
| | content of 80 wt. %, commercially available from Dow |
| CDI | Polymeric carbodiimide powder having carbodiimide content of minimum |
| | 13 wt. % and melting in range of 100-120° C., available from Lanxess, |
| | Europe as Stabaxol. |
| CDI-MB | A master batch of PBT (as mentioned above) and 3.5 wt. % of CDI (as |
| | mentioned above) |
| ELV | Reactive elastomeric ethylene acrylate - glycidyl methacrylate terpolymer, |
| | having a density of 0.94 g/cm3, a melt flow rate of 8 g/10 min (ISO 1133, |
| | 190° C., 21.6 kg) commercially available as ELVALOY 4170 from DOW. |
| MZP | Mono Zinc Phosphate, used as a quencher and commercially available |
| | from Budenheim as Budit T-21. |
| SAPP | Sodium acid pyrophosphate (SAPP) available from |
| NaSt | Sodium stearate available from PMC Biogenix, Inc, USA |
| AO | Stabilizer - hindered phenol Antioxidant Irganox 1010 from BASF |
| CB | A masterbatch consisting of 25 wt. % carbon black and 75 wt. % bisphenol |
| | A polycarbonate homopolymer having a melt flow rate (MFR) of 7 g/10 min |
| | in accordance with ASTM D 1238 (300° C., 1.2 kg). |

### Comparative Examples (CE1-CE4) and Examples (E1-E6): Table 2

TABLE 2
Formulations and properties for the PC/PBT thermoplastic compositions

| Sample # | CE1 | CE2 | CE3 | CE4 | CE5 | E1 | E2 | E3 | E4 | E5 | E6 |
|---|---|---|---|---|---|---|---|---|---|---|---|
| PC | 57.72 | 57.6 | 61.72 | 61.6 | 56.6 | 56.72 | 53.62 | 53.87 | 62.67 | 58.67 | 60.62 |
| PBT | 30 | 30 | 30 | 30 | 30 | 30 | 30 | 30 | 30 | 30 | 1.1 |
| ABS | 12 | 12 | | | 12 | 12 | 12 | 12 | | 7 | |
| MBS | | | 8 | 8 | | | | | 3 | | 8 |
| CDI | | | | | 1 | 1 | 0.5 | 0.25 | 1 | 1 | |
| CDI-MB | | | | | | | | | | | 30 |
| ELV | | | | | | | | | 3 | 3 | |
| MZP | 0.08 | | 0.08 | | | 0.08 | 0.08 | 0.08 | 0.08 | 0.08 | 0.08 |
| SAPP | | 0.2 | | 0.2 | 0.2 | | | | | | |
| NaSt | | | | | | | | | 0.05 | 0.05 | |
| AO | 0.2 | 0.2 | 0.2 | 0.2 | 0.2 | 0.2 | 0.2 | 0.2 | 0.2 | 0.2 | 0.2 |
| CB | | | | | | | 3.6 | 3.6 | | | |
| Total | 100 | 100 | 100 | 100 | 100 | 100 | 100 | 100 | 100 | 100 | 100 |

| | Unit of | | | | | | | | | | | |
|---|---|---|---|---|---|---|---|---|---|---|---|---|
| Properties | measure | CE1 | CE2 | CE3 | CE4 | CE5 | E1 | E2 | E3 | E4 | E5 | E6 |
| NII @ RT | kJ/m² | 62 | 61 | 60 | 59 | 61 | 62 | 63 | 63 | 69 | 68 | 64 |
| NII @ HA | kJ/m² | 43 | 34 | 26 | 20 | 34 | 50 | 47 | 47 | 58 | 62 | 53 |
| NII (Ret) | % | 69 | 56 | 44 | 33 | 56 | 80 | 74 | 76 | 84 | 93 | 82 |
| HDT | ° C. | 95 | 95 | 95 | 96 | 92 | 90 | 91 | 93 | 92 | 90 | 94 |
| Tensile | Gpa | 2116 | 2144 | 2114 | 2124 | 2144 | 2166 | 2246 | 2232 | 2094 | 2068 | 2104 |
| Modulus | | | | | | | | | | | | |
| Tensile | Mpa | 56 | 56 | 57 | 57 | 56 | 57 | 57 | 57 | 56 | 53 | 57 |
| Strength | | | | | | | | | | | | |
| EB | % | 67 | 95 | 77 | 106 | 95 | 113 | 79 | 88 | 108 | 100 | 116 |

The amounts in Table 2 are in weight percent based on the total weight of the composition. In all the examples, the total amount of components, equals 100 weight percent. Table 2 shows that thermoplastic compositions comprising PC/PBT and an impact modifier viz. ABS or MBS in absence of the hydrolytic stabilizer of the present invention (CE1 to CE4) do not show a desired hydro-ageing property in terms of notched Izod impact retention determined in accordance with the method set out above. However, in presence of a hydrolytic stabilizer composition comprising a compound having diimide functional groups, the composition is shown to demonstrate desired hydro-ageing property in terms of notched Izod impact retention determined in accordance with the method set out above (E1 to E3). Table 2 also demonstrates that a zinc phosphate based quencher is preferred over a sodium phosphate based quencher in order to achieve the desired properties as set out in the invention (CE5 vs. E1).

Furthermore, a combination of two different hydrolytic stabilizers, one having diimide functional group and another one having epoxy functional groups, also shows similar effect in accordance with the invention (E4 and E5). E6 demonstrates the use of a master batch of PBT and 3.5 wt. % of the carbodiimide hydrolytic stabilizer to obtain the thermoplastic composition in accordance with the present invention, to achieve the desired technical properties.

1. A thermoplastic composition comprising, based on the weight of the composition
(A) from 40 to 70 wt. % of aromatic polycarbonate;
(B) from 20 to 40 wt. % of polyester;
(C) from 1 to 15 wt. % of impact modifier;
(D) from 0.1 to 10 wt. % of a hydrolytic stabilizer composition comprising at least one compound containing diimide functional groups; and
(E) from 0 to 5 wt. % of other components,
wherein, the combined amounts of (A) to (E) is 100 wt. %, and wherein the composition is selected to have, in combination,
an initial notched Izod impact determined in accordance with ISO 180-1A at a temperature of 23° C. of at least 50 kJ/m²,
a notched Izod impact retention of at least 70% determined in accordance with the method set out in the description,
a heat distortion temperature, determined in accordance with ISO 75A flatwise at a load of 1.8 MPa, of at least 90° C.

2. The thermoplastic composition of claim 1 wherein the polyester does not comprise or consist of poly(lactic acid).

3. The thermoplastic composition of claim 1, wherein the polyester comprises, based on the weight of the polyester, at least 80 wt. % of poly(butylene terephthalate).

4. The thermoplastic composition of claim 1, wherein the impact modifier comprises or consists of at least one of acrylonitrile-butadiene-styrene (ABS) polymer and methacrylate-butadiene-styrene (MBS) polymer.

5. The thermoplastic composition of claim 1, wherein the hydrolytic stabilizer composition further comprises at least one compound containing epoxy functional groups.

6. The thermoplastic composition of claim 1, wherein the aromatic polycarbonate comprises two or more aromatic polycarbonates having different melt volume rates and/or wherein the polyester comprises two or more poly(butylene terephthalate) s having different intrinsic viscosities.

7. The thermoplastic composition of claim 1, wherein the aromatic polycarbonate comprises or consists of bisphenol A polycarbonate or a mixture of bisphenol A polycarbonates.

8. The thermoplastic composition of claim 1, wherein the aromatic polycarbonate has a weight average molecular weight of 15,000 to 60,000 g/mol determined using gel permeation chromatography with polystyrene standards and/or wherein the polyester has an intrinsic viscosity of 0.4 to about 2.0 dl/g as measured in a 60:40 phenol/tetrachloroethane mixture at 23° C.

9. The thermoplastic composition of claim 1, wherein component (E) comprises, based on the weight of the composition, from 0.01 to 1 wt. % of a compound selected from the group consisting of Group IB metal phosphate salts and Group IIB metal phosphate salts.

10. The thermoplastic composition of claim 1, wherein the component (E) comprises, based on the weight of the composition, from 0.01 to 1 wt. % of a compound, containing at least one of alkali metal cations or alkaline earth metal cations and a halide anion.

11. Method for the manufacture of the thermoplastic composition of claim 1, comprising the steps of:
a) combining polyester with the hydrolytic stabilizer composition, and optionally the other components in a first melt mixing device so as to form a stabilized polyester,
b) combining said stabilized polyester with polycarbonate and the impact modifier in a second melt mixing device.

12. An article comprising or consisting of the thermoplastic composition of claim 1.

13. The article of claim 12 wherein said article is comprised in or constitutes any one or more selected from the group consisting of instrument panels, cup holders, glove boxes, dashboards, dashboard carriers, door claddings, door fixtures, armrests, pillar cladding, seat cladding, boot cladding and parts used in heating, ventilation and/or air conditioning instruments.

14. A vehicle or an electrical equipment comprising the article of claim 12.

15. A method for the manufacture of an article comprising molding the thermoplastic composition of claim 1.
